(19) United States
(12) Patent Application Publication
(10) Pub. No.: US 2013/0290080 A1
(43) Pub. Date: Oct. 31, 2013

(54) SOCIAL MEDIA PRODUCT RESERVATION

(71) Applicant: Nike, Inc., (US)

(72) Inventors: Tim Pacholke, Tigard, OR (US); Jahan Behbahany, Lake Oswego, OR (US); Chase Louis Taylor, Portland, OR (US); Sunny Miller, Portland, OR (US); Jeff McPike, Portland, OR (US)

(73) Assignee: NIKE, Inc., Beaverton, OR (US)

(21) Appl. No.: 13/870,806

(22) Filed: Apr. 25, 2013

Related U.S. Application Data
(60) Provisional application No. 61/638,365, filed on Apr. 25, 2012.
(60) Provisional application No. 61/648,781, filed on May 18, 2012.

(51) Int. Cl. G06Q 30/06

(52) U.S. Cl. CPC G06Q 30/0601
USPC 705/14.4; 705/26.1

(57) ABSTRACT

Systems and methods for reserving products that have limited availability are provided. A social networking service may be used to announce the availability of reservations for limited availability products. The announcements may be at times unknown to consumers. Consumers may respond to the announcements via the social networking service and create virtual lines for the limited availability products.

### CROSS-REFERENCE TO RELATED APPLICATIONS

This application claims priority to U.S. Provisional Patent Application No. 61/638,365 filed Apr. 25, 2012 and entitled “Product Reservation” as well as U.S. Provisional Patent Application No. 61/648,781 filed May 18, 2012 and entitled “Social Media Product Reservation” both of which are incorporated in the present disclosure in their entirety.

### BACKGROUND

It is common for stores to sell products that have limited availability. For example, a company or store may produce a limited edition product that will be sought after by collectors. Stores selling new products that are part of an initial product offering may also find that there are more consumers than products available. Consumers seeking products that have limited availability may wait in lines at brick and mortar stores for extended time periods. Some consumers may spend several hours camped outside of a store prior to the store opening in hopes of obtaining a product with limited availability. Similar issues may occur when consumers try to make reservations for events or services.

Standing in long lines in hopes of obtaining a product with limited availability can result in a negative shopping experience for consumers. This is particularly true when consumers wait outside of brick and mortar stores during inclement weather. Of course, some consumers will leave without a product even after waiting. A negative shopping experience can result in consumers not wanting to purchase products from a particular store or manufacturer in the future.

Therefore, there is a need in the art for improved systems and methods for matching products having limited availability with consumers.

### BRIEF SUMMARY

The following presents a simplified summary in order to provide a basic understanding of some aspects of the disclosure. The summary is not an extensive overview of the disclosure. It is neither intended to identify key or critical elements of the disclosure nor to delineate the scope of the disclosure. The following summary merely presents some concepts of the disclosure in a simplified form as a prelude to the description below.

Systems and methods for reserving products, services and/or events that have limited availability are provided. A social networking service may be used to announce the availability of reservations for limited availability products, events or services. The announcements may be at times unknown to consumers. Consumers may respond to the announcements via the social networking service and create virtual lines for the limited availability products, events or services. In some embodiments, consumers may respond to announcements to reserve products, events or services. In other embodiments, consumers are only provided a place in line if a product, event or service is available. For example, if only 50 products are available, only 50 consumers will receive a place in line.

Some embodiments can be partially or wholly implemented on a computer-readable medium, for example, by storing computer-executable instructions or modules, or by utilizing computer-readable data structures.

Of course, the methods and systems of the above-referenced embodiments may also include other additional elements, steps, computer-executable instructions, or computer-readable data structures.

The details of these and other embodiments are set forth in the accompanying drawings and the description below. Other features and advantages will be apparent from the description and drawings, and from the claims.

### BRIEF DESCRIPTION OF THE DRAWINGS

The present disclosure is illustrated by way of example and not limited in the accompanying figures in which like reference numerals indicate similar elements and in which:

FIG. 1 illustrates an example computing device that may be used to implement aspects of the disclosure.

FIG. 2 illustrates an infrastructure that may be used to implement a product reservation system in accordance with an example embodiment.

FIG. 3 illustrates a product reservation process in accordance with an example embodiment.

FIG. 4 illustrates an example product reservation system that may be used to implement aspects of the disclosure.

### DETAILED DESCRIPTION

In the following description of the various embodiments, reference is made to the accompanying drawings, which form a part hereof, and in which is shown by way of illustration various embodiments in which the disclosure may be practiced. It is to be understood that other embodiments may be utilized and structural and functional modifications may be made without departing from the scope and spirit of the present disclosure. Further, headings within this disclosure should not be considered as limiting aspects of the disclosure. Those skilled in the art with the benefit of this disclosure will appreciate that the example embodiments are not limited to the example headings.

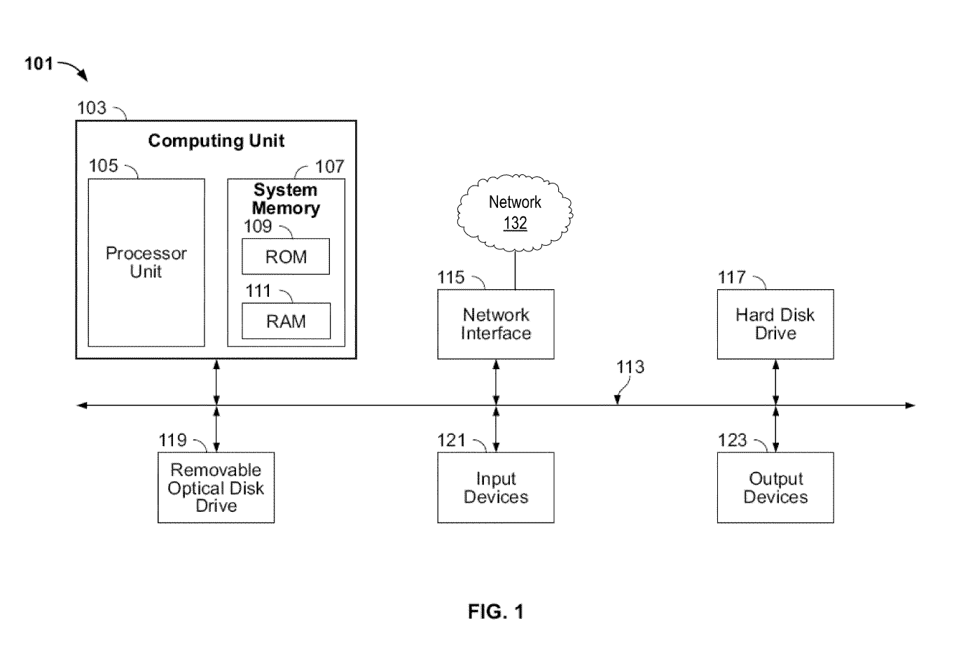

FIG. 1 illustrates an exemplary computer 101 that may be used to implement aspects of the disclosure. Computer 101 may include computing unit 103, which may comprise at least one processing unit 105. Processing unit 105 may be any type of processing device for executing software instructions, such as for example, a microprocessor device. Computer 101 may include a variety of non-transitory computer readable media, such as memory 107. Memory 107 may include, but is not limited to, random access memory (RAM) such as RAM 111, and/or read only memory (ROM), such as ROM 109. Memory 107 may include any of: electronically erasable programmable read only memory (EEPROM), flash memory or other memory technology, CD-ROM, digital versatile disks (DVD) or other optical disk storage, magnetic storage devices, or any other medium that can be used to store the desired information and that can be accessed by computer 101.

The processing unit 105 and the system memory 107 may be connected, either directly or indirectly, through a bus 113 or alternate communication structure to one or more peripheral devices. For example, the processing unit 105 or the system memory 107 may be directly or indirectly connected to additional memory storage, such as a hard disk drive 117, a removable magnetic disk drive, an optical disk drive 119, and a flash memory card. The processing unit 105 and the system memory 107 also may be directly or indirectly connected to one or more input devices 121 and one or more output devices 123. The output devices 123 may include, for example, a display device, television, printer, stereo, or speakers. In some embodiments one or more display devices may be incorporated into eyewear. The display devices incorporated into eyewear may provide feedback to users. Eyewear incorporating one or more display devices also provides for a portable display system. The input devices 121 may include, for example, a keyboard, touch screen, a remote control pad, a pointing device (such as a mouse, touchpad, stylus, trackball, or joystick), a scanner, a camera or a microphone.

Computer 101, computing unit 103, and/or any other electronic devices may be directly or indirectly connected to one or more network interfaces, such as example interface 115 for communicating with a network, such as network 132. In the example of FIG. 1, network interface 115, may comprise a network adapter or network interface card (NIC) configured to translate data and control signals from the computing unit 103 into network messages according to one or more communication protocols, such as the Transmission Control Protocol (TCP), the Internet Protocol (IP), and the User Datagram Protocol (UDP). These protocols are well known in the art, and thus will not be discussed here in more detail. An interface 115 may employ any suitable connection agent for connecting to a network, including, for example, a wireless transceiver, a power line adapter, a modem, or an Ethernet connection. Network 132, however, may be any one or more information distribution network(s), of any type(s) or topology(s), alone or in combination(s), such as internet(s), intranet(s), cloud(s), LAN(s). Network 132 may be any one or more of cable, fiber, satellite, telephone, cellular, wireless, etc. Networks are well known in the art, and thus will not be discussed here in more detail. Network 132 may be variously configured such as having one or more wired or wireless communication channels to connect one or more locations (e.g., schools, businesses, homes, consumer dwellings, network resources, etc.), to one or more remote servers, or to other computers, such as similar or identical to computer 101. Indeed, the system may include more than one instance of each component (e.g., more than one computer 101, more than one display, etc.).

Regardless of whether computer 101 or other electronic device within network 132 is portable or at a fixed location, it should be appreciated that, in addition to the input, output and storage peripheral devices specifically listed above, the computing device may be connected, such as either directly, or through network 132 to a variety of other peripheral devices, including some that may perform input, output and storage functions, or some combination thereof.

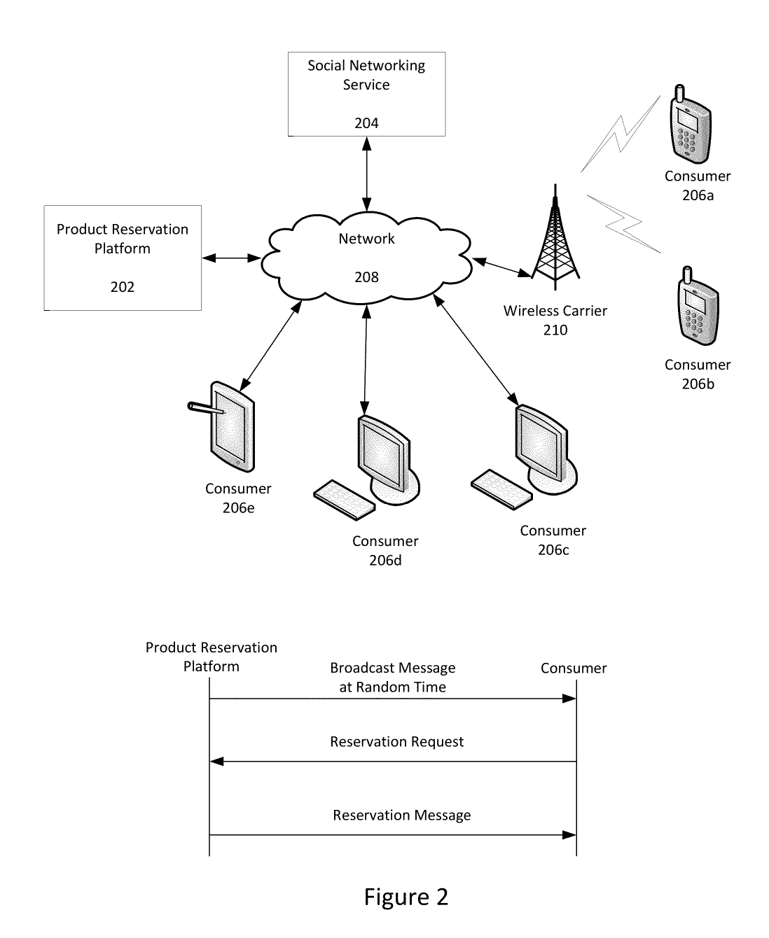

FIG. 2 illustrates an infrastructure that may be used to implement a product reservation system in accordance with an example embodiment. A product reservation platform 202 may be used to generate messages and process requests. Product reservation platform 202 may be hosted on a server operated by a store or company. Product reservation platform 202 may use a social networking service 204 to broadcast messages to consumers 206a-206e. Exemplary social networking services include Twitter, Facebook and Google+. In some embodiments, social networking service 204 may be used to both broadcast messages to a plurality of consumers and exchange messages with individual consumers. Twitter, for example, allows users to create Tweets that are broadcasted to all followers of the Tweet source. Twitter also allows parties to exchange direct messages that are not shared with other followers, e.g., via direct message.

The broadcasting and exchanging of messages may occur over a wide area network 208, such as the Internet. Communication links may also include one or more wireless carriers, such as wireless carrier 210. Some embodiments may include a wireless carrier connected to a wide area network.

Consumers may use a variety of devices to receive broadcast messages and exchange messages. Mobile terminals 206a and 206b may be implemented with smart phones and connect to wide area network 208 via wireless carrier 210. Desktop computers 206c and 206d may connect to wide area network 208 via an Ethernet connection or other conventional connection. Tablet device 206e may connect to wide area network 208 using WiFi or any other conventional wireless protocol.

As shown in FIG. 2, product reservation platform 202 may broadcast a message announcing the availability of reservation requests for a limited availability product to multiple consumers. The time of the broadcast may be a random or pseudo-random time selected by a computer device. Alternatively, the time of the event may also be selected by an event or launch planner. The time of the broadcast could be known by some people, but not the intended recipients, such as the consumers. After receiving the broadcast message, a consumer may respond with a reservation request. As will be described in more detail below, product reservation platform 202 may process multiple reservation requests on a first come first serve basis and send reservation messages to consumers who were able to successfully reserve a product.

Product reservation platform 202 may perform a variety of functions associated with a marketing campaign. For example, the platform may be used to capture and implement launch details as well as compose and schedule social media broadcast messages. The platform may also be used to track reservation confirmations and failures and provide overall analytics. Product reservation platform 202 may also contain logic that will prevent abuse liking setting quantity limits (1) per person; issuance of a reservation code; and capturing/storing information for consumers to verify at the point of pick up and purchase. Product reservation platform 202 may also have integrations with customer data management systems that will support highly targeted segmentation of announcement messages. A loyalty program may be started where consumers pre-register for product launches and identify preferred product attributes and/or interests.

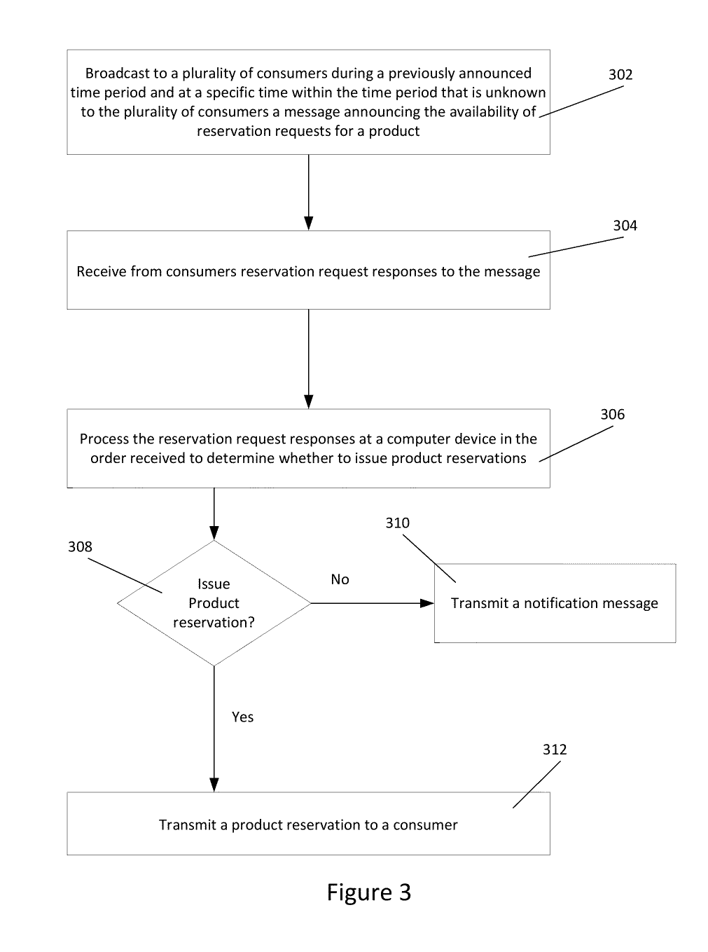

FIG. 3 illustrates a product reservation process in accordance with an example embodiment. In various embodiments some or all of the steps shown in FIG. 3 may be implemented by product reservation platform 202 shown in FIG. 2. First in step 302, a message source broadcasts to a plurality of consumers a message announcing the availability of reservation requests for a product. The broadcast may be sent via a social networking service. The broadcast may occur during a previously announced time period and at a specific time within the time period that is unknown to the plurality of consumers. For example, a store may inform consumers that they will broadcast a message announcing the availability of reservation requests for a product on a certain day. The store may then transmit the message at a random or pseudo-random time during that day. Alternatively, the store may transmit the message at a predetermined time that is not known to the consumers. The product reservation system may also broadcast a reminder message prior to broadcasting the message announcing the availability of product reservation requests.

The message may identify information needed in reservation requests. The needed information may include a product color, product size, and any other information used to identify specific products, e.g., a hashtag (#hashtag). The message may also identify a website that can be used to provide product reservation requests and/or to purchase products. One or more advertising messages may also be transmitted during the previously announced time period and prior to broadcasting the message announcing the availability of reservation requests.

In some example embodiments, the product reservation system may specify a predetermined syntax the product reservation request must conform to in order to receive a product reservation in response. In these examples, the product reservation may not issue a product reservation if the product reservation request does not comply with the predetermined syntax. In other example embodiments, the product reservation system may offer a second chance if the product reservation request does not comply with the predetermined syntax. In these other example embodiments, the product reservation system may send a follow-up message to an individual notifying the individual that the previously received product reservation request did not comply with the predetermined syntax and indicate the predetermined systax that should be used for the product reservation request message. In response to receipt of the follow-up message, an individual may send a second product reservation request message complying with the predetermined syntax. The product reservation system may thus provide a product reservation in response to the second product reservation request message if the message complies with the predetermined syntax.

One example of a syntax that may be employed for product reservation request message may be: [unique hashtag], [first name][last name], [shoe size]. Accordingly, a broadcast message may be, for example, “Twitter #RSVP is now open for new Air Foamposite One #Electrolime” and a corresponding product reservation request message may be, for example, “#Electrolime, First_Name Last_Name, 10.5” which complies with the predetermined syntax in this example. It will be appreciated that additional or alternative syntaxes may be selectively employed.

Next, in step 304 reservation requests are received in response to the broadcast announcement message. Reservation requests may be addressed to a single entity. In some embodiments, the product reservation platform may set a response time period, e.g., 60 minutes. The product reservation platform may, for example, only issue product reservations to product reservation requests received within the response time period. In some embodiments Twitter direct messaging may be used to send reservation requests. In step 306 reservation request responses are processed at a computer device in the order received to determine whether to issue product reservations. Step 306 may include comparing attributes included in reservation requests, such as colors and sizes, to available inventory. In other embodiments attributes in reservation requests may be compared to available seat assignments or a list of available appointments. Product reservation platform 202 or another component may parse incoming messages to access the attributes. After the processing is performed in step 306, it is determined whether to issue a product reservation in step 308. When a product reservation will not be issued, in a step 310 a notification message may be transmitted. When a product reservation will be issued, in a step 310 the product reservation is transmitted to the consumer in step 312. In some embodiments, steps 306-312 may be performed by product reservation platform 202 and/or one or more other components in an automated manner.

In addition to a product reservation confirmation, the product reservation system may process a product reservation request and generate various types of notification messages. For example, the product reservation system may process the product reservation request and determine that the requested product or requested size is not recognized or no longer available, and the notification message may indicate the same to the consumer. The product reservation system may also determine whether the consumer already has a pending product reservation, and the notification message may indicate the consumer has already received a product reservation.

It will be appreciated that alternative types of media channels may be employed to implement the product reservation system. Furthermore, combinations of various types of media channels may be employed to implement the product reservation system. For example, one type of media channel (e.g., Twitter) may be employed to broadcast the announcement of the availability of the reservation request, and a different type of media channel (e.g., phone) may provide the response having the reservation request.

Alternative embodiments may use push notification features. For example, Android and iOS mobile devices include push notification features that may be used to implement aspects of the disclosure. A consumer may download an application and preregister. As part of the preregistration process consumers may be registered to participate in product launches exclusive to that application. By pre-registering consumers may offer up additional bits of information (shoe/apparel sizes, interests, set up of express checkout, etc.) and that information may be used to target product launches to the right individuals (you could also consider this a loyalty program) and all they need to do is respond to a push notification to buy or reserve. Push notifications may also be used to send consumers targeted messages that match consumers interest and only requires an ‘acknowledgement’ of push notification to purchase. Some embodiments may also be implemented with a website and not a social networking service.

Those skilled in the art will appreciate that aspects of the disclosure are not limited to use with products. In other embodiments the methods and systems described herein may be used in connection with services that have limited availability. The product reservation system may also be employed with respect to products for which availability is not limited, but for which a reservation may be desirable, e.g., products having a high-demand with the potential for significant wait times to purchase. It should also be appreciated that “product” as used in this description refers to physical goods, services, and any other purchasable things. Some embodiments may also include providing preferred consumers or others with messages announcing the availability of reservation requests for a product before a general broadcast to others.

The product reservation system may also include an administrative platform, module, interface, dashboard, etc. for creating new product launch campaigns, composing and initiating the broadcast of the initial message indicating the RSVP period has begun, monitoring issued reservations, and facilitating other administrative functions.

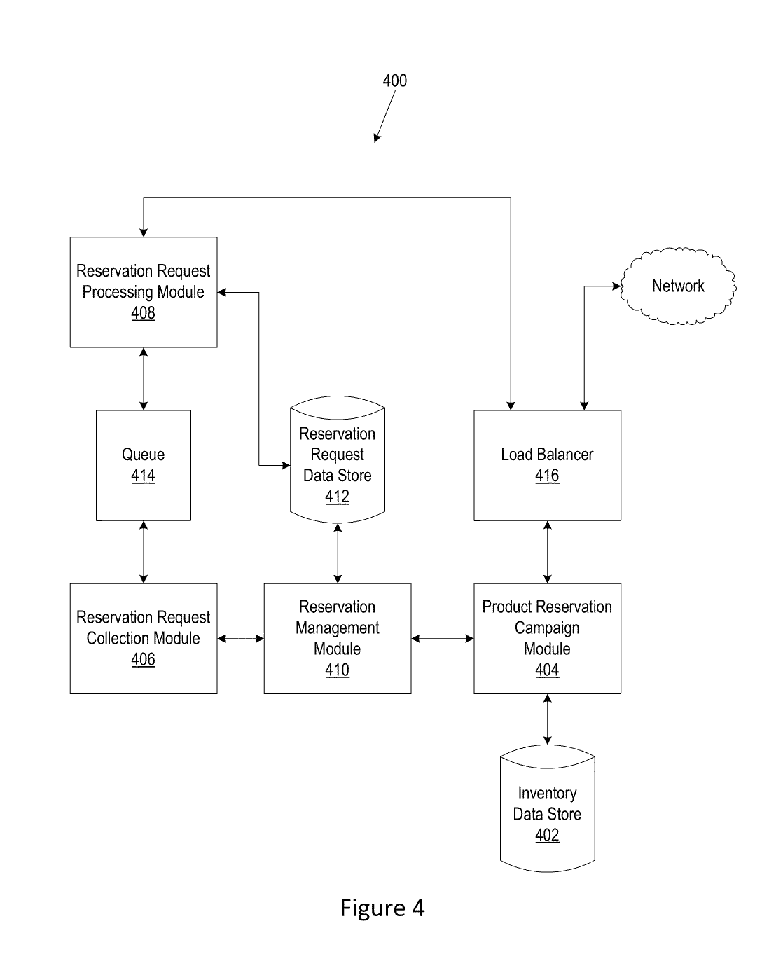

FIG. 4 illustrates an example of a product reservation system 400 that may be implemented in accordance with aspects of the disclosure. The product reservation system 400 automates the product reservation process allowing consumers to reserve products and/or services via, e.g., the Twitter interface. The product reservation system 400 manages inventory at an inventory data store 402, communicates with consumers using a product reservation campaign module 404, receives reservation requests via a reservation request collection module 406, and processes reservation requests at a reservation request processing module 408. The product reservation system 400 also includes a reservation management module 410 that manages product reservations stored at a product reservation data store 412. The result is an elevated consumer experience and streamlined process that advantageously decreases overhead and margin for error in creating and running product reservation campaigns.

The product reservation campaign module 404 may be a load balanced application that serves as the user interface for the product reservation system 400. An administrator may utilize the product reservation campaign module 404 to update inventory, create and configure product reservation campaigns, and monitor active product reservation campaigns. The product reservation campaign module 404 may also initiate the broadcast of the message announcing the availability of product reservations, e.g., by sending the initial campaign Tweet.

Once the product reservation campaign has begun, the reservation management module 410 may monitor the campaign, e.g., by tracking the campaign Twitter feed. The reservation management module 410 may be a lightweight application that tracks the reservation request collection module 406. The reservation management module 410 may also serve as the interface to the reservation data store 412.

The reservation request collection module 406 may connect with Twitter to collect the reservation requests received in response to receipt of the message announcing the availability of reservation requests. The product reservation system 400 may include multiple reservation request collection modules 406. The reservation request collection module 406 may receive the reservation requests as, e.g., direct messages. The reservation request collection module 406 may perform the initial processing of the reservation requests and route the reservation requests to be processed. The product reservation system 400 may maintain a queue 414 of pending reservation requests waiting to be processed by a reservation request processing module 408.

The reservation request processing module 408 may include the business logic used to process the reservation requests as described above. The product reservation system 400 may include multiple reservation request collection modules 408. The reservation request processing module 408 determines if the content of a reservation request matches any products that are currently available. If the reservation request processing module 408 recognizes a product and determines the product is available, it sends a request back to the product reservation campaign module 404 to finalize and issue the product reservation. The product reservation campaign module may perform some final checks to before issuing the reservation, e.g., a check to ensure the product reservations are not overbooked.

The product reservation system 400 may sustain both the possibility for outages (availability) and the occasional spikes in traffic (scalability). The system 400 may be configured to be modular and highly decoupled. Resource intensive modules may be replicated to provide extra resources in an ad hoc fashion to respond to traffic patterns. Additionally, the use of a reservation request queue 414 advantageously avoids any blocking of connections. A load balancer 416 may be employed to facilitate collection and processing of reservation requests. A caching system may also be employed to help to ensure that the product reservation system 400 can respond to reservation requests quickly.

Aspects of the embodiments have been described in terms of illustrative embodiments thereof. Numerous other embodiments, modifications and variations within the scope and spirit of the appended claims will occur to persons of ordinary skill in the art from a review of this disclosure. For example, one of ordinary skill in the art will appreciate that the steps illustrated in the illustrative figures may be performed in other than the recited order, and that one or more steps illustrated may be optional in accordance with aspects of the embodiments.

What is claimed is:

1. A method comprising:
(a) broadcasting a message to a plurality of consumers during a previously announced time period and at a specific time within the time period that is unknown to the consumers wherein the message announces the availability of reservation requests for a product;
(b) receiving from at least some of the consumers reservation requests in response to receipt of the message by the consumers;
(c) processing the reservation requests at a computer device in the order received to determine whether to issue respective product reservations; and
(d) issuing a product reservation to one of the consumers in response to a determination to issue the product reservation to the consumer.

2. The method of claim 1, wherein the time period is announced via a social networking service.

3. The method of claim 2, wherein the message identifies information required to be in a reservation request in order to receive a product reservation.

4. The method of claim 3, wherein the message identifies a website that will process a purchase of the product.

5. The method of claim 1, further including broadcasting to the consumers at least one marketing message prior to and the same day as broadcasting the message announcing the availability of reservation requests for the product.

6. The method of claim 1, wherein (c) comprises comparing at least one product attribute received in one of the reservation requests to available inventory.

7. The method of claim 1, wherein (a) comprises broadcasting the message announcing the availability of reservation requests for the product via a social networking service.

8. The method of claim 1 wherein (b) comprises respectively receiving the reservation requests as direct messages via a social networking service.

9. The method of claim 1 wherein the time period comprises a 24 hour time period.

10. The method of claim 1 wherein the time period comprises a 2 day time period.

11. A method comprising:
(a) broadcasting a message to a plurality of electronic devices during a previously announced time period and at a specific time within the time period that is unknown to a plurality of end users wherein the message announces the availability of reservation requests for a product;
(b) receiving from at least a portion of the electronic devices, electronic reservation requests in response to receipt of the message at the electronic devices;
(c) processing the electronic reservation requests at a computer device of a product reservation platform in the order received to determine whether to issue respective product reservations; and
(d) issuing a product reservation to an electronic device associated with a specific end user in response to a determination to issue a product reservation to the end user.

12. A product reservation system comprising:
a product reservation campaign module that initiates a broadcast of a message to a plurality of consumers during a previously announced time period and at a specific time within the time period that is unknown to the consumers wherein the message announces the availability of reservation requests for a product;
a reservation request collection module that receives reservation requests from at least some of the consumers in response to receipt of the message by the consumers;
a reservation request processing module that processes the reservation requests to determine whether to issue respective product reservations; and
wherein the reservation campaign module issues a product reservation to one of the consumers in response to a determination to issue the product reservation to the consumer.

13. The system of claim 12 wherein the reservation campaign module announces the time period and initiates the broadcast of the message via a social networking service.

14. The system of claim 13 wherein:
the message identifies information required to be in a reservation request in order to receive a product reservation;
the reservation request processing module determines to issue product reservations when respective reservation requests include the information; and
the reservation request processing module determines not to issue product reservations when respective reservation requests do not include the information.

15. The system of claim 14 wherein the message identifies a website that will process a purchase of the product.

16. The system of claim 12 wherein the reservation request processing module compares at least one product attribute received in one of the reservation requests to available inventory.

17. The system of claim 12 wherein the product reservation campaign module broadcasts at least one marketing message to the consumers prior to and the same day as broadcasting the message announcing the availability of reservation requests for the product.

18. The system of claim 12 wherein the reservation request collection module respectively receives the reservation requests as direct messages via a social networking service.

19. The system of claim 12 wherein the time period is at least one of a 24 hour time period and a 2 day time period.

20. The system of claim 12 wherein:
the product reservation campaign module broadcasts the message via a first media channel of a first type; and
the reservation request collection module receive the reservation requests via a second media channel of a second type that is different than the first type.
